(19) United States
(12) Patent Application Publication
(10) Pub. No.: US 2011/0280024 A1
(43) Pub. Date: Nov. 17, 2011

(54) LIGHT GUIDE SHEET AND MOVABLE CONTACT UNIT INCLUDING THE SAME

(75) Inventors: KOJI TANABE, Osaka (JP); NAOKI TATEHATA, Kyoto (JP); HIROTOSHI WATANABE, Osaka (JP)

(73) Assignee: PANASONIC CORPORATION, Osaka (JP)

(21) Appl. No.: 13/100,406

(22) Filed: May 4, 2011

(30) Foreign Application Priority Data
May 12, 2010 (JP) 2010-109792

(51) Int. Cl. F21V 11/00

(52) U.S. Cl. 362/351

(57) ABSTRACT

The light guide sheet has a base of a light transmissive film, a first light-extracting section, and a second light-extracting section. The light-extracting sections having pits and projections are formed on a surface of the base. The base has a first color converter at least at a part corresponding to the position having the first light-extracting section in a thickness direction of the base. The first color converter converts light from a light source into a first color. Forming a color converter for predetermined color at each part corresponding to a plurality of the light-extracting sections allows the one color emitted from a light-emitting element to be converted into differently colored light beams at the light-extracting sections. The structure offers various patterns of illumination without increase in number of the light-emitting element.

### TECHNICAL FIELD

The technical field relates to a light guide sheet and a movable contact unit including the sheet, which are mainly used for operating electronic equipment.

### BACKGROUND ART

Mobile electronic devices, such as a mobile phone and an electronic camera, having easy operation even in the dark have been increasing in recent years. In such devices, for example, the display face having push buttons on the operation panel is illuminated by light from a light-emitting diode or an electroluminescence device. To keep up with demand, manufacturers have been seeking an improved movable contact unit and a switch with easy operation and various illuminating patterns, for example, as is disclosed in Japanese Unexamined Patent Application Publication No. 2009-205940.

First, conventional structures of a light guide sheet and a movable contact unit will be described with reference to FIGS. 6 and 7. For a better understanding of the structure, the dimensions thereof are partially enlarged in the drawings. FIG. 6 is a sectional view of a conventional switch. FIG. 7 is a plan view of the conventional switch. The switch has light guide sheet 3, base sheet 4, movable contact 5, wiring board 7, fixed contact 8, light-emitting element 9, and display sheet 10.

Light guide sheet 3 has base 1 and light-extracting section 2. Base 1 is a light transmissive film. Light-extracting section 2, which is formed of pits and projections, is disposed at a predetermined section on the lower surface of base 1. The structure, as is shown in FIGS. 6 and 7, has a plurality of light-extracting sections 2 formed of light-extracting sections 2A, 2B, and 2C. Band-shaped notches are formed between light-extracting sections 2. Specifically, notch 1A is disposed between light-extracting sections 2A and 2B, and notch 1B is disposed between light-extracting sections 2B and 2C.

Base sheet 4 is a light transmissive film. A plurality of movable contacts 5 is made of sheet metal and each of which is formed into a nearly dome shape. Base sheet 4 is bonded to the lower surface of light guide sheet 3 at predetermined sections in the periphery of base sheet 4 by adhesive (not shown). Each of movable contacts 5 is attached to the lower surface of base sheet 4 at a section located under each light-extracting section 2. Light guide sheet 3, base sheet 4, and movable contacts 5 form movable contact unit 6.

Wiring board 7 has a plurality of wiring patterns (not shown) on both surfaces. A plurality of fixed contacts 8 is disposed on the upper surface of wiring board 7. Each of fixed contacts 8 has central fixed contact 8A and peripheral fixed contact 8B. Central fixed contact 8A of a round shape is surrounded by peripheral fixed contact 8B of a horseshoe or a ring shape. Each movable contact 5 is disposed on wiring board 7 in a manner that the periphery of movable contact 5 is mounted on peripheral fixed contact 8B and the center of the lower surface of movable contact 5 faces central fixed contact 8A at an interval.

Light-emitting element 9 is, for example, a light-emitting diode. A plurality of light-emitting elements 9 (9A, 9B) is mounted on the upper surface of wiring board 7 so as to be located at a side section of light guide sheet 3. For example, as is shown in FIG. 7, light-emitting element 9A is disposed on the right side of light-extracting section 2A and light-emitting element 9B is disposed on the left side of light-extracting section 2B. Each of elements 9A and 9B is disposed on wiring board 7, with the light-emitting face of the element faced the edge of base 1.

Display sheet 10 is a light transmissive film. Printed section 10A is formed under display sheet 10 by printing, for example. Printed section 10A has a plurality of display sections 10B formed of characters cut out of predetermined sections of printed section 10A. Display sheet 10 is disposed on light guide sheet 3 in a way that display sections 10B are positioned above light-extracting sections 2. A conventional switch has the structure above.

Such structured switch is attached to the operation panel of a mobile phone or other electronic devices; meanwhile, central fixed contacts 8A, peripheral fixed contacts 8B, and light-emitting elements 9 are connected to electronic circuits (not shown) of a device via wiring patterns.

Having the structure above, the switch works as follows. When a user pushes down display section 10B of display sheet 10, light guide sheet 3 and base sheet 4 disposed therebeneath bend down, by which the center of dome-shaped movable contact 5 is pushed down. Having a pushing force, movable contact 5 elastically bends downward with a click response and the center of the lower surface of movable contact 5 makes contact with central fixed contact 8A. This brings electrical connections between central fixed contact 8A and peripheral fixed contact 8B via movable contact 5.

When the pushing force on display sheet 10 is removed, movable contact 5 elastically returns to its original dome shape, allowing the center of movable contact 5 to go away from central fixed contact 8A. That is, central fixed contact 8A is electrically disconnected from peripheral fixed contact 8B.

The electrical connection/disconnection between central fixed contact 8A and peripheral fixed contact 8B is used for switching various functions of the device. Besides, through the electrical connections between central fixed contact 8A and peripheral fixed contact 8B, electric power is provided to light-emitting elements 9 through the electronic circuits of the device, allowing light-emitting elements 9A and 9B to emit light. For example, when light-emitting element 9A emits orange light and light-emitting element 9B emits green light, the orange light enters from the right side and the green light enters from the left side of light guide sheet 3. Having reflection in base 1, the light entered from both the sides propagates inward.

Further, the light propagating in base 1 is reflected on light-extracting sections 2A and 2B and is diffused, which illuminates display section 10B of display sheet 10 from downward. In the structure above, orange light illuminates display section 10B located above light-extracting section 2A, whereas green light illuminates display section 10B located above light-extracting section 2B. By virtue of such illuminated operation panel, the user easily recognizes the characters on display section 10B even in the dark, enhancing operation performance.

Further, notches 1A and 1B are formed between light-extracting sections 2. In a case where light-extracting sections 2A and 2B are illuminated differently in color by light-emitting element 9A (emitting orange, for example) and light-emitting element 9B (emitting green, for example), the notches prevent the display section from being illuminated by color-blended light. In a case where only a certain area of the display section needs to be illuminated—for example, the area of light-extracting section 2A is turned off, while the area of light-extracting section 2B is turned on, the notches prevent the turned-off area from being dimly illuminated by light leaked from the turned-on area.

### SUMMARY

In conventional movable contact unit 6 and a switch, however, the illumination in different color is attained by using light-emitting elements 9A and 9B emitting light in different color. Increasing illumination color of light-extracting sections 2 needs increase in number of light-emitting element 9 so as to emit light of desired color. This increases a parts count, and accordingly increases production cost.

A light guide sheet and movable contact unit including the light guide sheet according to various embodiments described hereinafter achieves a simple structure at a low cost, which offers various illuminating patterns.

The light guide sheet has a base and first and second light-extracting sections. The base include a light transmissive film. The light-extracting sections having at least one of pits and projections are formed on a surface of the base. The base has a first color converter at least at a part corresponding to the position having the first light-extracting section in a thickness direction of the base. With the structure above, the light guide sheet offers various illuminating patterns without increase in number of the light-emitting elements.

### BRIEF DESCRIPTION OF DRAWINGS

FIG. 1 is a sectional view of a movable contact unit in accordance with a first exemplary embodiment.

FIG. 2 is a plan view of the movable contact unit in accordance with the first exemplary embodiment.

FIG. 3 is a sectional view of a switch in accordance with the first exemplary embodiment.

FIG. 4 is a sectional view of a movable contact unit in accordance with a second exemplary embodiment.

FIG. 5 is a plan view of the movable contact unit in accordance with the second exemplary embodiment.

FIG. 6 is a sectional view of a conventional switch.

FIG. 7 is a plan view of the conventional switch.

### DETAILED DESCRIPTION OF THE INVENTION

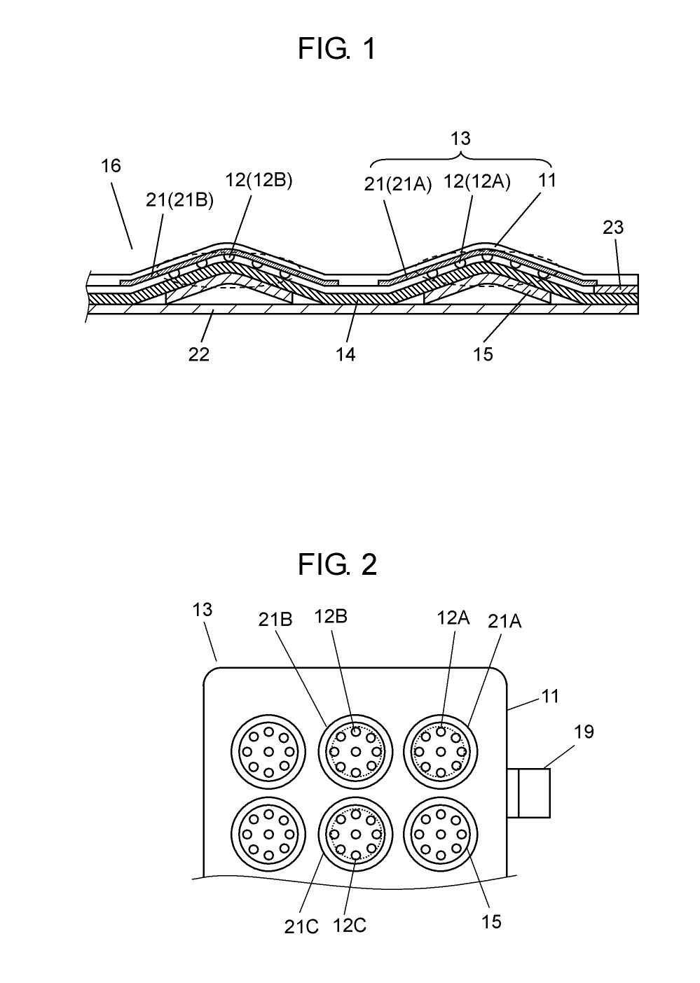

The exemplary embodiments of A light guide sheet and movable contact unit including the light guide sheet are described hereinafter with reference to the accompanying drawings, FIG. 1 through FIG. 5. For a better understanding of the structure, the dimensions thereof are partially enlarged throughout the drawings.

### First Embodiment

FIG. 1 is a sectional view of a movable contact unit in accordance with the first exemplary embodiment. FIG. 2 is a plan view of the movable contact unit in accordance with the first exemplary embodiment of.

Movable contact unit 16 has light guide sheet 13, base sheet 14, and movable contact 15. Light guide sheet 13 has base 11 and light-extracting section 12. Base 11 is a light transmissive film with flexibility. Base 11 is made of swellable resin, such as polyurethane, silicone, styrene, and polycarbonate. White or opaque white light-extracting section 12 is formed of projections. Base 11 has a plurality of light-extracting sections 12 at predetermined sections of the lower surface. Light-extracting sections 12 are formed on base 11 in a manner that polyester or epoxy is printed like dots on base 11 by, for example, printing. Light-extracting sections 12 is not necessarily formed of projections, they may be pits formed on base 11 itself. Such pits may be formed on base 11 by laser processing. As another way, the pits can be formed by pressing a projecting mold against base 11. Further, the light-extracting section 12 may be a combined structure of pits and projections.

Base 11 has color converter 21 at least at a part corresponding to the position having light-extracting section 12 in a thickness direction of base 11. Color converter 21 converts the color of light from a light source into predetermined color. As an example, FIG. 2 shows that light-extracting section 12 contains light-extracting section 12A (as the first light-extracting section), light-extracting section 12B (as the second light-extracting section), and light-extracting section 12C (as the third light-extracting section). At a part corresponding to light-extracting section 12A, base 11 has color converter 21A for first-color (for example, blue) conversion. At a part corresponding to light-extracting section 12B, base 11 has color converter 21B for second-color (for example, red) conversion. At a part corresponding to light-extracting section 12C, base 11 has color converter 21C for third-color (for example, green) conversion. Light guide sheet 13 is thus structured. More specifically, the light extracting section 12A is formed on a first predetermined portion of the base. The light extracting section 12B is formed on a second predetermined portion of the base. The light extracting section 12C is formed on a third predetermined portion of the base, respectively. And the color converter 21A is disposed in a thickness direction of the base on the first predetermined portion of the base. The color converter 21B is disposed in a thickness direction of the second predetermined portion of the base. The color converter 21C is disposed in a thickness direction of the base on the third predetermined portion of the base. The first through third light-extracting sections and the first through third colors are not necessarily limited to those described above.

Color converter 21 is formed by impregnating the material of base 11 with dye through the following procedures. First, ink of predetermined colors (of, for example, blue or red) is prepared by dissolving a dye of the color into solvent. As for solvent used here, it should preferably be a solvent having a swelling effect on the material of base 11. Preferable combinations of a solvent and a dye according to the material of base 11 are as follows: for polyurethane base 11, a solvent of acetone or cyclohexanone and an azo-based dye; for silicone base 11, a solvent of gasoline or benzene and an oil-soluble metal complex dye; and for polycarbonate base 11, a solvent of toluene or xylene and an azo-based dye. Next, such prepared ink is sprayed on the surface of base 11 by ink jet printing. After that, base 11 is heated for 10-40 minutes at temperature of about 100-160° C. Color converter 21 is thus formed.

As for the ink above, acrylic resin or phenoxy resin may be further added thereto. Such prepared ink may be printed on the surface of base 11 by screen printing, instead of ink jet printing. In this case, too, base 11 is swelled by a solvent containing a predetermined dye so that the dye seeps into base 11. In this way, blue-colored color converter 21A, red-colored color converter 21B, and green-colored color converter 21C are formed.

As is described above, each of color converters 21A, 21B, and 21C is formed by impregnating base 11 with dye.

Base sheet 14 is a flexible film of polyethylene terephthalate or polycarbonate. Movable contact 15 is made of sheet metal, such as copper alloy and steel, and shaped into a dome. Base sheet 14 is bonded to the lower surface of light guide sheet 13 at predetermined sections in the periphery of base sheet 14 by acrylic or silicone adhesive 23. A plurality of movable contacts 15 is attached to the lower surface of base sheet 14 at a section located under each light-extracting section 12.

Movable contact unit 16 may contain separator 22. Separator 22 is a film of polyethylene terephthalate. Separator 22 is disposed beneath base sheet 14 so as to cover all the lower surface of base sheet 14. Having separator 22 protects movable contacts 15 from dust to be collected on the lower section of movable contacts 15 during storage and transportation of movable contact unit 16.

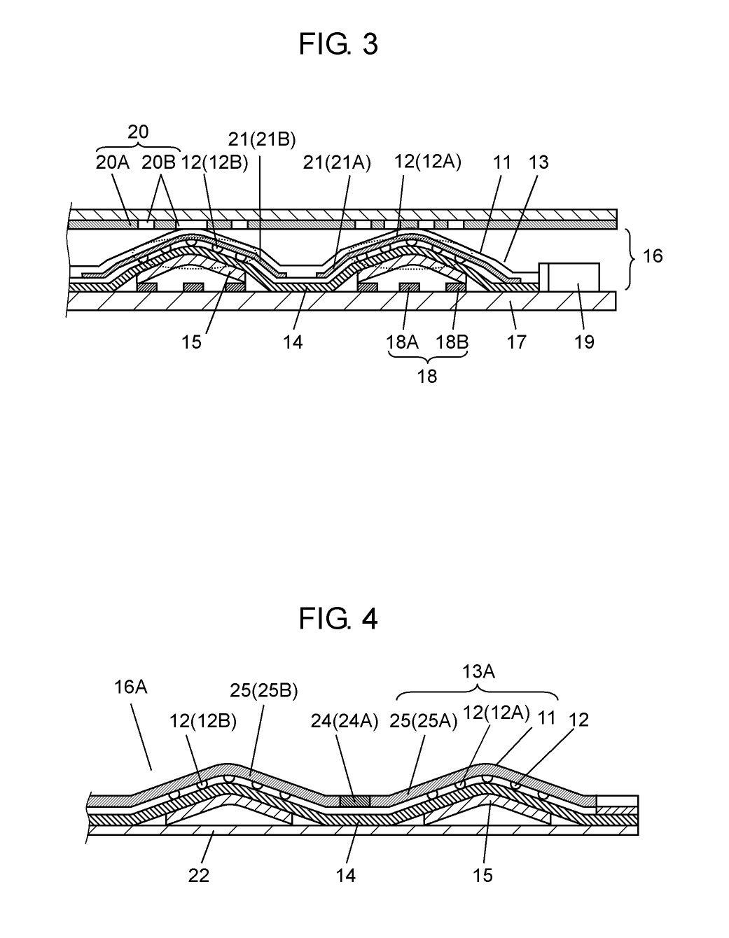

FIG. 3 is a sectional view of a switch including movable contact unit 16. The switch has movable contact unit 16, wiring board 17, light-emitting element 19, and display sheet 20. Wiring board 17 is a film of polyethylene terephthalate or polycarbonate. As another possibility, wiring board 17 may be a plate of paper phenol or epoxy containing glass. Wiring board 17 has a plurality of copper wiring patterns (not shown) on both surfaces. A plurality of fixed contacts 18, which is made of copper or carbon, is disposed on the upper surface of wiring board 17. Each of fixed contacts 18 has central fixed contact 18A and peripheral fixed contact 18B. Central fixed contact 18A of a round shape is surrounded by peripheral fixed contact 18B of a horseshoe or a ring shape.

On the upper surface of wiring board 17, movable contact unit 16 (from which separator 22 has been removed) is disposed. Movable contact unit 16 is disposed on wiring board 17 in a manner that the periphery of movable contact 15 is mounted on peripheral fixed contact 18B and the center of the lower surface of movable contact 15 faces central fixed contact 18A at an interval.

Light-emitting element 19 is an illuminant of, for example, a light-emitting diode. As shown in FIGS. 2 and 3, light-emitting element 19 is mounted on the upper surface of wiring board 17 so as to be located at a side section of light guide sheet 13, with the light-emitting face of the element faced the edge of base 11. Two-or-more light-emitting elements 19 may be disposed on the wiring board according to the size and intended use of the switch.

Display sheet 20 is a light transmissive film made of polyethylene terephthalate (PET) or polycarbonate sheet. Printed section 20A is formed under display sheet 20 by printing, for example. Printed section 20A has a plurality of display sections 20B formed of characters cut out of predetermined sections of printed section 20A. Display sheet 20 is mounted on movable contact unit 16 in a way that display sections 20B are positioned above light-extracting sections 12 of light guide sheet 13.

Such structured switch is attached to the operation panel of a mobile phone or other electronic devices; meanwhile, central fixed contacts 18A, peripheral fixed contacts 18B, and light-emitting elements 19 are connected to electronic circuits (not shown) of a device via wiring patterns.

Having the structure above, the switch works as follows. When a user pushes down display section 20B of display sheet 20, light guide sheet 13 and base sheet 14 disposed therebeneath bend down, by which the center of dome-shaped movable contact 15 is pushed down. Having a pushing force, movable contact 15 elastically bends downward with a click response and the center of the lower surface of movable contact 15 makes contact with central fixed contact 18A. This brings electrical connections between central fixed contact 18A and peripheral fixed contact 18B via movable contact 15.

When the pushing force on display sheet 20 is removed, movable contact 15 elastically returns to its original dome shape, allowing the center of movable contact 15 to go away from central fixed contact 18A. That is, central fixed contact 18A is electrically disconnected from peripheral fixed contact 18B.

The electrical connection/disconnection between central fixed contact 18A and peripheral fixed contact 18B is used for switching various functions of the device. Besides, through the electrical connections between central fixed contact 18A and peripheral fixed contact 18B, electric power is provided to light-emitting element 19 through the electronic circuits of the device, allowing light-emitting elements 19 to emit light. The white light from light-emitting element 19 enters from the edge of light guide sheet 13 into base 11. Having reflection within base 11, the light propagates inward.

Further, the light propagating in base 11 has reflection and diffusion at light-extracting sections 12A and 12B. The light beams diffused at light-extracting section 12 pass through color converters 21A, 21B, and 21C and illuminate display section 20B of display sheet 20 from downward. For example, suppose that color converter 21 has converter 21A for blue conversion, converter 21B for red conversion, and converter 21C for green conversion. In display section 20B, a part above light-extracting section 12A is illuminated by blue light, a part above light-extracting section 12B is illuminated by red light, and a part above light-extracting section 12C is illuminated by green light. By virtue of such illuminated operation panel, the user easily recognizes the characters on display section 20B even in the dark, enhancing operation performance.

According to the structure of the embodiment, base 11 has color converter 21 for predetermined color conversion disposed on each of the parts corresponding to a plurality of light-extracting sections 12. The structure allows display sections 20B to have multicolored illumination by single light-emitting element 19, and therefore, no need for employing light-emitting elements 19 by color.

Besides, color converter 21 is formed by impregnating the material of base 11 with dye. Therefore, highly durable color converter 21 is obtained.

Color converter 21 is formed partially in base 11 in the direction of thickness of base 11. That is, in the area corresponding to light-extracting section 12, base 11 has a part without color converter 21 in the direction of thickness, as well as a part having color converter 21. The structure allows light from light-emitting element 19 to retain the original color component of element 19 until reaching color converter 21 located far from the incident plane of base 11. This effectively works for determining the color of light fed from each color converter 21 with accuracy.

Further, color converter 21 is located on the side of the surface on which light-extracting section 12 is to be formed in the direction of thickness of base 11. That is, after color converter 21 is formed, light-extracting section 12 can be formed on the same side, i.e., with no need for turning base 11 upside down. The structure reduces the steps of forming light guide sheet 13.

The description above has been given on the structure in which light-extracting section 12 has each color converter 21. However, color converter 21 may not be formed at a part of display section 20B that needs to be illuminated by the original emission color of light-emitting element 19. Light-emitting element 19 is not limited to a white-color emitting element; a light-emitting element that emits different color, such as orange and green, may be employed. This increases the range of combination color of light-emitting element 19 and color converter 21, contributing to multi-colored illumination.

According to the structure of the embodiment, base 11 has color converter 21 for predetermined color conversion at a section corresponding to each of light-extracting sections 12. This allows light-extracting sections 21 to have different colors by light-emitting element 19 of a single emission color. That is, multi-colored illumination is obtained with no increase in number of light-emitting element 19. This contributes to cost-reduced, simply structured light guide sheet 13 and movable contact unit 16.

### Second Embodiment

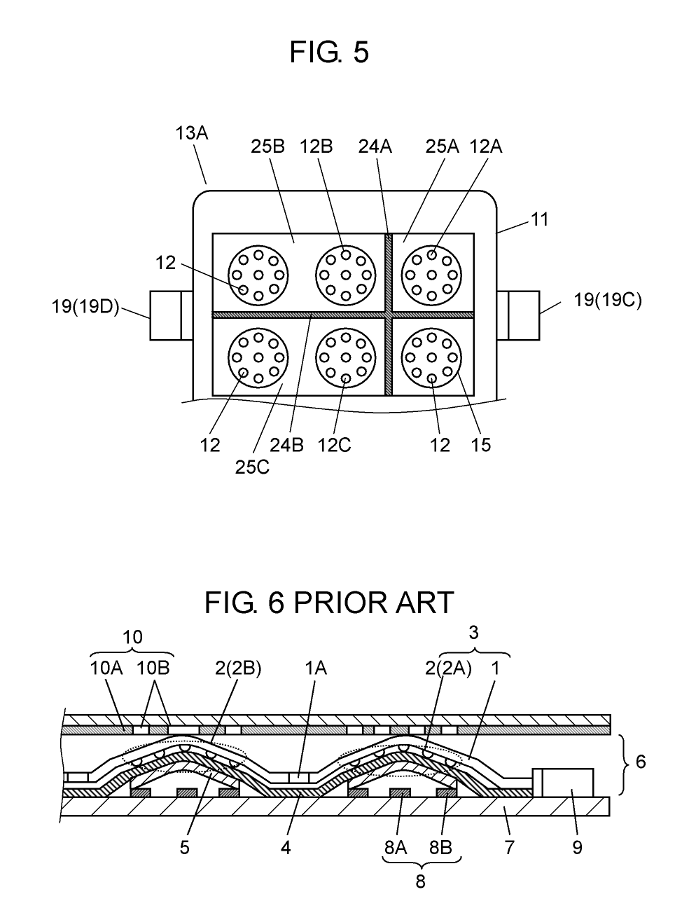

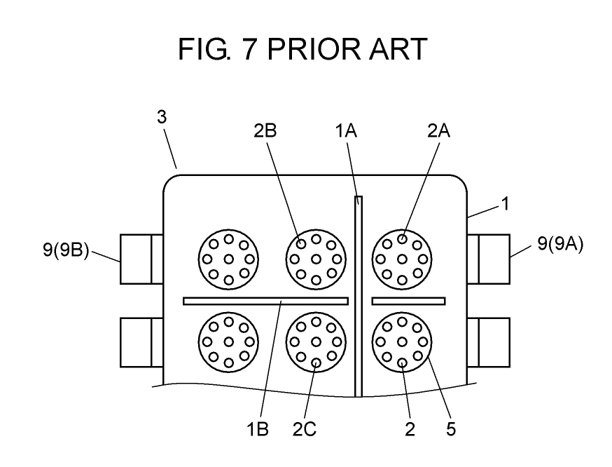

FIG. 4 is a sectional view of a movable contact unit in accordance with the second exemplary embodiment. FIG. 5 is a plan view of the movable contact unit in accordance with the second exemplary embodiment. In FIGS. 4 and 5, like parts are identified by the same reference marks as in the structure of the first embodiment and the description thereof will be omitted.

The structure of the embodiment differs from that of the first exemplary embodiment in that color converter 25 is formed throughout the thickness of base 11.

Further, base 11 has light-blocking section 24 of a band shape between color converters 25. Light-blocking section 24 is darkly colored in, for example, black, deep blue, or deep purple. In the structure of the embodiment, light-blocking section 24A is formed between color converter 25A (as a first color converter) and color converter 25B (as a second color converter); similarly, light-blocking section 24B is formed between color converter 25B and color converter 25C (as a third color converter). Light-blocking section 24 blocks the light passing through base 11.

Color converter 25 is formed through processes similar to those of the first embodiment. That is, ink is applied to the surface of base 11 by ink jet printing or screen printing, and then base 11 is impregnated with a dye of a predetermined color. Light-blocking section 24 is formed simultaneously with the step of forming color converters 25A and 25B in base 11. Procedures for forming light-blocking section 24 are described below. The description is given on an example where color converter 25A for blue color (as a first color) conversion, color converter 25B for red color (as a second color) conversion, and light-blocking section 24A are formed in light guide sheet 13A. First, blue ink for color converter 25A is applied to the parts where color converter 25A and light-blocking section 24A are to be formed. After that, like in the procedure described in the first embodiment, the ink-applied parts undergo heat treatment at a predetermined temperature, by which base 11 is impregnated with dye contained in the blue ink. Next, red ink for color converter 25B is applied to the parts where color converter 25B and light-blocking section 24A are to be formed. After that, the ink-applied parts similarly undergo heat treatment. Through the procedures above, light-blocking section 24A of dark purple (as blended color of blue and red) is formed.

As described above, base 11 is impregnated with two kinds of dye to form light-blocking section 24A.

In this ways, light-blocking section 24A is formed simultaneously with the step of forming color converters 25A and 25B in base 11. Employing the structure further reduces manufacturing steps and provides light guide sheet 13 with various patterns of illumination.

Movable contact unit 16A is formed of light guide sheet 13A described above, base sheet 14, and movable contact 15. When movable contact unit 16A is employed for a switch as in a manner similar to the first embodiment, the unit is mounted on the upper surface having a plurality of fixed contacts 18 of wiring board 17, and then display sheet 20 is disposed over the unit in a manner that display section 20B is positioned above light-extracting section 12 of light guide sheet 13A (see FIG. 3).

According to the switch of the embodiment, as is shown in FIG. 5, white light-emitting element 19C is disposed on the right side of light guide sheet 13A, and white light-emitting element 19D is disposed on the left thereof.

Such structured switch is attached to the operation panel of a mobile phone or other electronic devices; meanwhile, fixed contacts 18 and light-emitting elements 19 are connected to the electronic circuits (not shown) of the device via a wiring pattern.

The switch having the structure above works similar to that described in the first embodiment. When a user pushes down display section 20B of display sheet 20, light guide sheet 13A and base sheet 14 disposed therebeneath bend down, by which movable contact 15 is pushed down. The electrical connection/disconnection between central fixed contact 18A and peripheral fixed contact 18B is used for switching various functions of the device.

On establishing the electrical connections, electric power is provided to light-emitting element 19 through the electronic circuits of the device, allowing light-emitting elements 19C and 19D to emit light. The white light from light-emitting elements 19C and 19D enters from both the edges of light guide sheet 13A into base 11. Having reflection within base 11, the light propagates inward. Further, the light propagating in base 11 has reflection and diffusion at light-extracting sections 12A and 12B. The light beams diffused at light-extracting sections 12A and 12B pass through color converters 25A and 25B and illuminate display section 20B of display sheet 20 from downward with each color converted at converters 25A and 25B.

Light guide sheet 13A has light-blocking section 24 between light-extracting sections 12. When display section 20B is illuminated with light of different colors (of, for example, blue color from light-extracting section 12A and red color from light-extracting section 12B), light-blocking section 24 prevents the two colors obtained from adjacent color converters 21 from being mixed with each other in light guide sheet 13A. This allows display section 20B to have clear illumination with an intended color. As shown in FIG. 5, light-blocking section 24A prevents the blue light emitted from light-extracting section 12A and the red light emitted from light-extracting section 12B from being mixed with each other. Further, light-blocking section 24B blocks leakage of the blue light and the red light into, for example, light-extracting section 12C. This prevents display section 20B located above light-extracting section 12C from being illuminated with blue and red.

For example, suppose that light-emitting element 19D is turned off and light-emitting element 19C is turned on. In that case, light-extracting section 12A emits light from light-emitting element 19C and the light is blocked by light-blocking sections 24A and 24B. The light-blocking sections prevent light-extracting sections 12B and 12C from emitting dim light. Employing the structure (i.e. forming dark-colored light-blocking sections 24A and 24B between color converters 25 in base 11) prevents mixture and leakage of light between light-extracting sections 12, providing clear and user-friendly illumination.

As described above, such structured light guide sheet 13A prevents mixture and leakage of light between light-extracting sections 12, providing clear and user-friendly illumination. Accordingly, movable contact unit 16A including the improved light guide sheet also offers the advantages.

Although the description above has been given on the structure where a plurality of light-extracting sections 12 having pits and projections formed on the lower surface of base 11 by printing, it is not limited thereto. Light-extracting sections 12 may be formed on the upper surface of base 11. Further, instead of printing, light-extracting sections 12 may be formed by various methods, for example, attaching, ink jet printing, laser processing, press working, and molding.

In the description above, a plurality of movable contacts 15 is attached to the lower surface of base sheet 14, and then the base sheet is attached to the lower surface of light guide sheet 13 (13A). The structure needs not necessarily base sheet 14; movable contacts 15 may be directly attached to the lower surface of light guide sheet 13 (13A). This contributes to reduced parts count of the structure, providing movable contact unit 16 (16A) and a switch with simple structure and low production cost.

The light guide sheet and the movable contact unit including the light guide sheet as discussed above offer not only cost reduced simple structure but also various patterns of illumination. They are particularly useful for operating electronic equipment.

What is claimed is:

1. A light guide sheet comprising:
a base including a light transmissive film;
a first light-extracting section including at least one of pits and projections formed on a surface of the base; and
a second light-extracting section including at least one of pits and projections formed on the surface of the base,
wherein, a first color converter for converting light from a light source into a first color is disposed in the base at least at a part, which corresponds to a position having the first light-extracting section, in a thickness direction of the base.

2. The light guide sheet of claim 1, wherein the first color converter is formed in the base by impregnating the base with dye of a predetermined color.

3. The light guide sheet of claim 1, wherein the first color converter is formed at a part on a side of the surface having the first and second light-extracting sections in a thickness direction of the base.

4. The light guide sheet of claim 1, wherein a second color converter for converting light from a light source into a second color is disposed in the base at least at a part corresponding to a position having the second light-extracting section in a thickness direction of the base.

5. The light guide sheet of claim 4, wherein the base has a light-blocking section between the first color converter and the second color converter so as to block light from passing through the base.

6. The light guide sheet of claim 5, wherein the first color converter and the second color converter are formed throughout thickness of the base.

7. The light guide sheet of claim 5, wherein the first color converter is formed by impregnating the base with dye of the first color, the second color converter is formed by impregnating the base with dye of the second color, and the light-blocking section is formed by impregnating the base with dye of the first color and dye of the second color.

8. A movable contact unit comprising:
a base of a light transmissive film;
a first light-extracting section including pits and projections formed on a surface of the base; and
a second light-extracting section including pits and projections formed on the surface of the base,
wherein, a first color converter for converting light from a light source into a first color is disposed in the base at least at a part corresponding to a position having the first light-extracting section in a thickness direction of the base, and a dome-shaped movable contact made of conductive sheet metal is disposed under the light-extracting sections of the light guide sheet.

9. A light guide sheet comprising:
a base including a light transmissive film;
a first light-extracting section including at least one of pits and projections formed on a first predetermined portion of the base; and
a second light-extracting section including at least one of pits and projections formed on a second predetermined portion of the base,
wherein the base includes a first color converter for converting light from a light source into a first color, the first color converter disposed in a thickness direction of the base on at least the first predetermined portion of the base.

10. A movable contact unit comprising:
the light guide sheet of claim 9; and
a dome-shaped movable contact made of conductive sheet metal disposed under the first and second light-extracting sections.

11. The light guide sheet of claim 9, further comprising a second color converter for converting light from a light source into a second color, the second color converter disposed in a thickness direction of the base on at least the second predetermined portion of the base.
